(19) United States
(12) Patent Application Publication
(10) Pub. No.: US 2021/0019711 A1
(43) Pub. Date: Jan. 21, 2021

(54) METHOD AND SYSTEM FOR A MOBILE APPLICATION TO CONNECT USERS WITH BEAUTY SERVICE PROVIDERS

(71) Applicant: Michael Romero, Albuquerque, NM (US)

(72) Inventor: Michael Romero, Albuquerque, NM (US)

(21) Appl. No.: 16/933,763

(22) Filed: Jul. 20, 2020

Related U.S. Application Data
(60) Provisional application No. 62/876,763, filed on Jul. 21, 2019.

(51) Int. Cl. G06Q 10/10; G06Q 20/08; G06Q 30/06; G06Q 30/02; G06F 16/953

(52) U.S. Cl. CPC G06Q 10/1095; G06Q 20/0855; G06Q 20/3267; G06Q 30/0282; G06F 16/953; G06Q 30/0623

(57) ABSTRACT

The Coiffure app allows beauty services to be provided world wide through the same system. A user downloads the app, choses his or her service from a variety of available services, such as cosmetology, barbering, manicures/pedicures, massage therapy, spa treatments, and dog grooming. Payment is provided online through the app, including the acceptance of tips. Users can review every licensed beauty professional registered with the app that they have an appointment with. Reviewers are made on a scale of 1 to 5 stars. Both customers and beauty professionals can leave comments. By registering with the Coiffure app, beauty professionals become independent contractors, running their own businesses.

### CROSS-REFERENCE TO RELATED APPLICATION

The present application is related to and claims priority from prior provisional application Ser. No. 62/876,763, filed Jul. 21, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of mobile software applications (apps) and more specifically relates to Coiffure, an app to connect users with beauty service providers who can accept the user's appointment request(s) and provide the user's required salon/beauty service.

### 2. Description of the Related Art

A mobile app is a computer program designed to run on a programmable device such as a smartphone, tablet computer, or other mobile devices. Mobile apps were originally offered for general productivity and information retrieval, including email, calendar, contacts, and stock market and weather information. The explosion in number and variety of apps made discovery a challenge, which in turn led to the creation of a wide range of review, recommendation, and curating sources, including blogs, magazines, and dedicated online app-discovery services. Many new apps are desirable to provide convenient solutions to the users.

In order to achieve success in the marketplace, any potential invention must meet two basic requirements. First, there must be a demonstrated need or desire among a group of people that the invention will satisfy. Second, a sufficient number of people must share that need or desire. To be successful, it isn't necessary that an invention be world-changing—it is only necessary that the invention meet a need or desire that a sufficient number of consumers have, at a price they are willing to pay.

Generally speaking, the current apps that connect users to professional beauty service providers require users to book an appointment with a specific spa or salon. Thus in order to get business, beauty service providers must either develop of list of clientele that will follow them wherever they go, or join a spa or salon, working for the owner. The Coiffure app is designed to help connect users and beauty service providers by providing an interface where users can indicate the beauty service and time, and any beauty service provider with the Coiffure app can chose to accept the appointment.

A wide variety of licensed professionals work in the beauty industry, including barbers, cosmetologists, nail techs, massage therapists, and dog groomers. Since the Coiffure app brings licensed professionals directly to the user, beauty professionals can maintain their own business while connecting directly with customers desiring their service through the app. Any licensed beauty professional in the area can elect to the user's proposed appointment if he or she desires. Appointments can be at any time and place, as arranged through the app.

Ideally, a method and system for a mobile application to connect users with beauty service providers should provide an app that connects users with beauty service providers and, yet would operate reliably and be manufactured at a modest expense. Thus, a need exists for a reliable method and system for a mobile application to connect users with beauty service providers to avoid the above-mentioned problems.

### BRIEF SUMMARY OF THE INVENTION

In view of the foregoing disadvantages inherent in the known mobile applications art, the present invention provides a novel Coiffure app. The general purpose of the present invention, as will be described subsequently in greater detail, is to connect users with beauty service providers who can accept the user's appointment request(s) and provide the user's required salon/beauty service.

The Coiffure app allows beauty services to be provided world wide through the same system. A user downloads the app, choses his or her service from a variety of available services, such as cosmetology, barbering, manicures/pedicures, massage therapy, spa treatments, and dog grooming. Payment is provided online through the app, including the acceptance of tips.

Every licensed beauty professional registered with the app can be reviewed by a user on a scale of 1 to 5 stars. Both customers and beauty professionals can leave comments. By registering with the Coiffure app, beauty professionals become independent contractors, running their own businesses.

The present invention holds significant improvements and serves as a method and system for a mobile application to connect users with beauty service providers should provide an app that connects users with beauty service providers. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a method and system for a mobile application to connect users with beauty service providers should provide an app that connects users with beauty service providers, constructed and operative according to the teachings of the present invention.

FIG. 1 is a perspective view illustrating a splash screen for the Coiffure app, according to an embodiment of the presently claimed invention.

FIG. 2 is a flowchart illustrating an example of how the information is transferred between various hardware devices for two users, according to an embodiment of the presently claimed invention.

FIG. 3 is a workflow diagram illustrating a method of use for the Coiffure app according to an embodiment of the presently claimed invention.

The various embodiments of the present invention will hereinafter be described in conjunction with the appended drawings, wherein like designations denote like elements.

### DETAILED DESCRIPTION

As discussed above, embodiments of the present invention relate to a a method and system for a mobile application to connect users with beauty service providers should provide an app that connects users with beauty service providers and more particularly to a mobile app as used to improve the ways for users to connect to any barber, cosmetologist, massage therapist, or dog groomer.

Generally speaking, the Coiffure app is an app that makes it easy for customers to connect with barbers, cosmetologists, massage therapists, and/or dog groomers. A user can sign in, even when traveling, and request an appointment at his or her convenience. Once connected, the user is connected with any licensed professional they choose. Licensed professionals registered with the app can review incoming appointments and decide whether to accept or decline the appointment.

Beauty professionals may also opt to purchase a mobile vehicle unit in order to provide services inside the vehicle, allowing the beauty professional to travel to the customer rather than the other way around.

The systems and techniques described herein can be realized or achieved in a number of ways, including digital electronic circuitry, application specific integrated circuits (ASICs), smartphone software, hardware, firmware, or any combination of the above. These various implementations of the claimed systems and techniques can be achieved through one or more computer programs, generally known as software, programs, software applications, and/or code.

The software can be implemented on a programmable system that includes one or more input devices, such as a smartphone, coupled to transmit and receive data from at least one programmable processor and a storage system. The software includes machine instructions for the programmable processor and the input devices, and can be implemented in any appropriate programming language for the respective specifics of the programmable processor and input devices.

The systems and techniques claimed herein can be implemented using a computing system that includes a front end component, such as a user's smartphone with the Coiffure app as a graphical user interface that can interact with an implementation of the system and techniques described herein, and a back end component, such as a data server, or a middleware component, such as an application server, or any combination of a front end component with a middleware component and/or a back end component.

The computing system can include a client device, such as a user's smartphone, and a server that are remote from each other and interact through a communication network. The client device and server have a relationship by virtue of the software running on the respective devices that creates a client-server relationship with each other.

The Coiffure app acts as a bridge to connect people who are looking for specific beauty services from licenced beauty professionals in their area, wherever that might be. In order to use the Coiffure app, a user signs up and creates an account. Professionals can also set up a professional member account with Coiffure that allows each professional member to accept or reject appointment requests and receive payments, while working as an independent contractor. The user's account information is stored on a server that is accessed by the user's network via the user's device. An approved account allows users to request appointments with specific beauty professionals in various geographic locations, and enter information for payment up front.

Once the user's request for an appointment has been transmitted, professional members of Coiffure can either accept or reject the user's request. If a professional accepts the offer, Coiffure will then notify the user that his or her appointment is accepted, and process the payment. Payment can be made using several third party payment processors, such as Visa, Mastercard, and Paypal. Once appointment is complete, the user can choose to leave a tip. Finally, the user can choose to give a rating to the professional on a scale of 1 to 5 so that other user's can see the reviews for individual professional members.

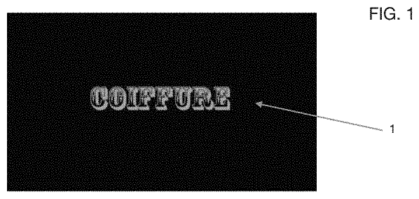

Referring to the drawings by numerals of reference, there is shown in FIG. 1 an example of a splash screen, including the Coiffure logo 1.

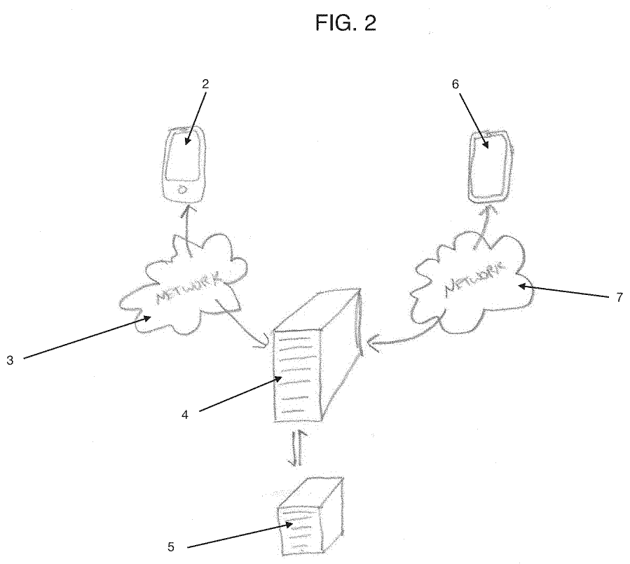

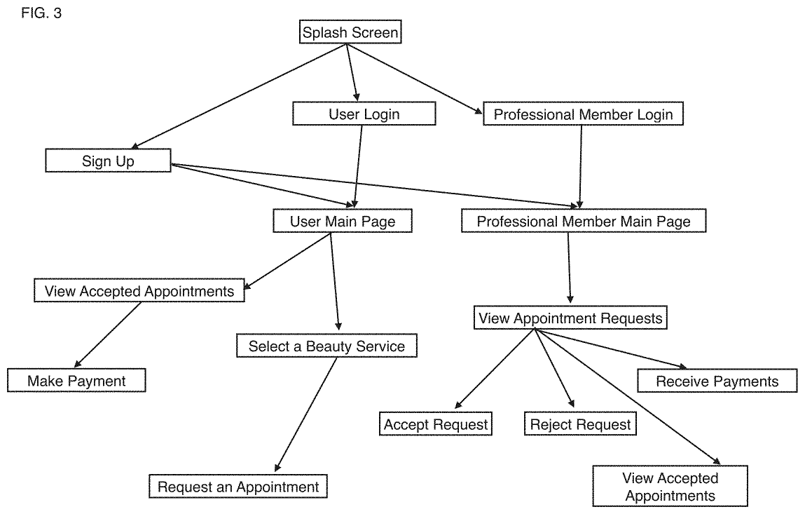

As shown in FIG. 2, the user's information, including login, appointment requests, appointment schedules, and payment information, is collected by the Coiffure app on each user's phone 2, 6, as shown in the flow chart in FIG. 3. The information is then sent by the user's selected cellular or other wireless network 3 to one or more centralized servers 4. The appointment request and acceptance/rejection steps are performed on a middle end component or a back end component or a combination of a middle end component and a back end component 4, as outlined in the flow chart in FIG. 3. The resulting acceptance or rejection of the user's appointment request is sent from the professional user's phone 6 over the user's network 7, which can be a cellular network, wireless network, and/or the Internet network. When payment is initiated, the user's payment is collected and transferred by a third party on the third party's server 5.

Referring now to FIG. 3, a broad work flow chart of the Coiffure app, the general steps in the method used by the Coiffure app are depicted.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results. All these embodiments are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

Additionally, the logic flows depicted in the figures do not require the specific order shown to achieved the desired object. Additional steps may be added, or steps may be removed, from the described flows, and other components added or removed, from the described systems, creating different implementations that are within the scope of the following claims.

What is claimed is new and desired to be protected by Letters Patent is set forth in the appended claims:

1. A method performed by one or more processing devices, the method comprising the steps of:
(a) displaying a graphical interface to a user via a first processing device;
(b) presenting a choice of service fields to the user via the graphical interface;
(c) in response to the users' selection, receiving information regarding one or more specific services in the selected service field, a price for each specific service, and a list of one or more professional member providers providing each specific service via a network connection between the first processing device and a storage device;
(d) displaying the received information on the first processing device for the user's selection;
(e) in response to the users' selection, receiving and storing an appointment request and payment information on the storage device via the network connection between the first processing device and the storage device,
wherein the appointment request contains information regarding the user's selection of a specific service and professional member provider;
(f) displaying a graphical interface to a professional member in the applicable industry via a second processing device;
(g) displaying the appointment request via the graphical interface on the second processing device;
(h) requesting an acceptance or a denial of the user's appointment request via the graphical interface on the second processing device;
(i) if the professional member rejects the user's appointment request, displaying a notification of rejection to the user via the graphical interface on the first processing device;
(j) if the professional member accepts the user's appointment request, displaying a notification of acceptance to the user via the graphical interface on the first processing device;
(k) in response to the professional member's acceptance the user's appointment request, accepting payment from the user through a network connection between the first processing device and a programmable payment processing device;
(l) displaying one or more accepted appointments to the user via an appointment schedule via the graphical interface on the first processing device;
(m) displaying one or more accepted appointments to the professional member via an appointment schedule via the graphical interface on the second processing device; and
(n) after any scheduled appointment, transferring the payment to the professional member through a network connection between the second processing device and the programmable payment processing device.

2. The method according to claim 1, the method comprising the further steps of:
(o) requesting feedback from the user via the graphical interface on the first processing device regarding the quality of the professional member's solution;
(p) in response to the request, receiving the requested feedback from the user via the network connection between the first processing device and the storage device; and
(q) storing the feedback on the storage device.

3. The method according to claim 2, the method comprising the further steps of:
(r) calculating an overall feedback rate for the professional member using the feedback received from the user and any previously received feedback related to the professional member;
(v) storing the calculated overall feedback rate for the professional member on the storage device; and
(w) displaying the calculated overall feedback rate for the professional member via the graphical interface of the first processing device and the graphical interface of the second processing device.

4. The method according to claim 1, the method comprising the additional step of:
(o) providing a login process, wherein the user can access a record of currently accepted and previously completed appointments once the login process is complete.

5. Two or more storage devices storing instructions that are executable to perform operations comprising:
(a) a first storage device displaying a first graphical interface to a user;
(b) requesting information from the user via the first graphical interface;
(c) in response to the request, receiving an appointment request from the user;
(d) storing the appointment request on the first storage device or one or more other storage devices;
(e) a second storage device displaying a second graphical interface to a professional member;
(f) displaying the appointment request to a professional member via the second graphical interface;
(g) requesting an answer regarding the appointment request via the second graphic interface;
(h) in response the request, receiving the answer from the professional member;
(i) storing the answer on the second storage device or the first storage device or one or more other storage devices;
(j) if the answer is positive, requesting payment from the user via the first graphical interface;
(k) accepting payment from the user;
(l) transferring payment to the professional member via the second graphical interface; and
(m) displaying a stored appointment schedule to the user via the first graphical interface and to the professional member via the second graphical interface.

6. The one or more storage devices according to claim 5, wherein the instructions are executable to perform additional operations comprising:
(n) permitting the user and the professional member to access the stored appointment schedule via a login process.

7. The one or more storage devices according to claim 5, wherein the instructions are executable to perform additional operations comprising:
(n) requesting feedback from the user via the first graphical interface, wherein the feedback regards the quality of the professional member's solution;
(o) in response to the request, receiving the requested feedback from the user; and
(p) storing the feedback on the first storage device, the second storage device, one or more other storage devices, or the first storage device and one or more other storage devices.

8. The one or more storage devices according to claim 7, wherein the instructions are executable to perform additional operations comprising:
(q) calculating an overall feedback rate for the professional member using the feedback received from the user and any previously received feedback related to the professional member;
(r) storing the calculated overall feedback rate for the professional member on the first storage device, the second storage device, one or more other storage devices, or the first storage device, the second storage device, and one or more other storage devices; and
(s) displaying the calculated overall feedback rate for the professional member via the first graphical interface the second graphical interface.
